(19) United States
(12) Patent Application Publication
(10) Pub. No.: US 2022/0188717 A1
(43) Pub. Date: Jun. 16, 2022

(54) DETERMINING RISK MITIGATION MEASURES FROM ASSESSED RISKS

(71) Applicant: International Business Machines Corporation, Armonk, NY (US)

(72) Inventors: Stan Kevin Daley, Atlanta, GA (US); Michael Bender, Rye Brook, NY (US); Rhonda L. Childress, Austin, TX (US); Sarbajit K. Rakshit, Kolkata (IN)

(21) Appl. No.: 17/122,476

(22) Filed: Dec. 15, 2020

(51) Int. Cl. G06Q 10/06; G06N 20/00; H04L 9/32

(52) U.S. Cl. CPC G06Q 10/0635; G06Q 10/06315; H04L 2209/38; G06N 20/00; H04L 9/3236; G06Q 10/063114

(57) ABSTRACT

A processor may receive information regarding risk mitigation approaches. The information regarding risk mitigation approaches may be stored in a database accessible to a risk assessment AI model. The processor may receive information regarding risks associated with the area. The processor may determine, using the risk assessment AI model, a current risk evaluation associated with the area. The processor may determine, using the risk assessment AI model, recommended risk mitigation measures based on the current risk evaluation.

### BACKGROUND

The present disclosure relates generally to the field of risk mitigation, and more specifically to determining risk mitigation measures based on a risk evaluation.

A variety of health and safety risks may exist in an area. Some of these health and safety risks may be created by or exacerbated by the behavior of individuals in the environment. When the risks reach a risk limit, they may need to be mitigated using proper techniques.

### SUMMARY

Embodiments of the present disclosure include a method, computer program product, and system for determining risk mitigation measures based on a risk evaluation.

A processor may receive information regarding risk mitigation approaches. The information regarding risk mitigation approaches may be stored in a database accessible to a risk assessment AI model. The processor may receive information regarding risks associated with the area. The processor may determine, using the risk assessment AI model, a current risk evaluation associated with the area. The processor may determine, using the risk assessment AI model, recommended risk mitigation measures based on the current risk evaluation.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1A is a block diagram of an exemplary system for determining risk mitigation measures based on a risk evaluation, in accordance with aspects of the present disclosure.

FIG. 1B is a flowchart of an exemplary method for determining risk mitigation measures based on a risk evaluation, in accordance with aspects of the present disclosure.

FIG. 2A illustrates an example blockchain architecture configuration, according to example embodiments.

FIG. 2B illustrates a blockchain transactional flow, according to example embodiments.

FIG. 3A illustrates a cloud computing environment, in accordance with aspects of the present disclosure.

FIG. 3B illustrates abstraction model layers, in accordance with aspects of the present disclosure.

FIG. 4 illustrates a high-level block diagram of an example computer system that may be used in implementing one or more of the methods, tools, and modules, and any related functions, described herein, in accordance with aspects of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

It will be readily understood that the instant components, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification, refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Aspects of the present disclosure relate generally to the field of risk mitigation, and more specifically to determining risk mitigation measures based on a risk evaluation. While the present disclosure is not necessarily limited to such applications, various aspects of the disclosure may be appreciated through a discussion of various examples using this context.

A variety of health and safety risks may exist in an area. Some of these health and safety risks may be created by or exacerbated by the behavior of individuals in the environment. When the risks reach a risk limit, they may need to be mitigated using proper techniques.

In some embodiments, a processor may receive information regarding risk mitigation approaches. In some embodiments, the information regarding risk mitigation approaches may relate to guidance regarding safety measures that protect people from safety or health risks. As an example, the safety or health risks may be associated with a health danger such as an infectious pathogen. In some embodiments, the risk mitigation approaches and safety measures may relate to the removal of a health danger, neutralization of the danger, sanitization of an area, use of protective equipment (e.g., masks, gloves) by individuals entering the area, use of protective equipment by individuals believed to have been previously exposed to the danger, use of protective equipment by individuals more likely to suffer greater health risks from exposure to the danger, limits to permissible exposure to the danger, estimates of the potential exposure to the danger created by various situations, etc. In some embodiments, the information and guidance may come from regulations from government agencies, non-governmental agencies, recommended best practices, scientific or medical publications, policies or procedures set by an employer or building, etc. (which may be ingested and evaluated using natural language processing).

In some embodiments, the information regarding risk mitigation approaches may be stored in a database accessible to a risk assessment artificial intelligence (“AI”) model. In some embodiments, the information regarding risk mitigation approaches may be assessed using natural language processing techniques to evaluate the information. In some embodiments, the information regarding risk mitigation approaches may be evaluated by the AI model to determine which guidance is applicable for a particular context. For example, the database may include different rules about safety measures. The AI model may be utilized to determine which rules are applicable given a location (e.g., different locations may be governed by different laws) and a threat level set by the local government (e.g., one that is based on the number of people that are ill in an area). Depending on the location and the threat level, different rules may determine what risk mitigation approaches to utilize. In some embodiments, the information regarding risk mitigation approaches may be updated to gather the most up-to-date guidance.

In some embodiments, the processor may receive information regarding risks associated with an area. In some embodiments, the information regarding risks associated with the area may include information about people who entered the area (or an area adjacent to or in proximity to the area). For example, a person infected with a pathogen may stand in the doorway of a conference room, but not enter the conference room, to speak with someone. In some embodiments, information may be obtained about how many people entered the area, where the people went within the area, what the people did in the area, when the people were in the area, other people who were previously in the area, etc. As an example, information about people entering the area may be obtained by counting measures (e.g., by determining how many times an elevator or door was used). As another example, information about what people did in the area may be obtained from information about activities planned for the area (e.g., meeting calendar invitations specifying invitees and the purpose for the meeting, class schedules specifying instructors and students, employee rosters for work shifts at a factory, etc.).

In some embodiments, the information about people may include information about a person's medical information (if provided by a person), including the likelihood that a person is infected with the pathogen (e.g., a high, medium, or low likelihood based on answers to a questionnaire about health symptoms or exposure to risk), medical conditions that make the person more susceptible to the pathogen, medical conditions that make the person a better vector for the pathogen, medical procedures (e.g., vaccine received), medical testing (e.g., positive test result indicating that a person is infected or a temperature check indicating the person has a fever), etc. In some embodiment, a person's medical information may be used to determine a more specific risk evaluation for the person. For example, if a person has had a vaccine (e.g., flu vaccine) and an area has been exposed to flu-based risk, the risk associated with the person may be reduced by the efficiency of the vaccine (e.g., if the flu vaccine is 65% effective, the risk may be reduced by 65% for the person for any risk factors related to the flu).

In some embodiments, any personal information (e.g., medical records) may be obtained only if an individual opts in to providing that information. In some embodiments, identifying information may be removed from the personal information. In some embodiments, access to personal information from personal devices (e.g. cell phone to identify a person) may be provided by an individual opting in, and access may be revoked by the individual at any time.

In some embodiments, if personal information is not available, the system may be configured to treat any person (as determined by shape analysis) as low, medium, or high risk, depending on the current circumstances or the location's preference. In some embodiments, if specific information is not available to label a person as low, medium, or high risk, the specific risk level assigned to the person may be based on the risk level of individuals that have passed through the location that have shared their personal information. In some embodiments, a person's specific risk level may be determined by a default setting (e.g., setting all individuals for whom personal information is not available to a medium risk level). In some embodiments, if a person has opted into a known contact tracing system, that data may also allow for modification of a person's specific risk level based on known risk levels of those with whom they have been in contact.

In some embodiments, the information regarding risks associated with the area may include information about specific activities taking place in, near, or around the area. In some embodiments, some activities may be associated with higher health or safety risk (e.g., different activities may be assigned different risk ratings). For example, certain types of dental procedures (e.g., taking place in a dental office) performed on people who are potentially exposed to a pathogen may result in the spread of the pathogen from the patient to the air, surfaces, and other people in the dental office. There may be higher risk associated with performing a dental cleaning than with performing a dental x-ray. In some embodiments, information about the specific activities taking place in an area at a certain time may be obtained from calendar events (e.g., dental appointments calendared), records maintained by the business (e.g., health records specifying the types of medical procedures a patient received), a ledger maintained by a location (e.g., a receptionist's record of people who visit a building and the reason for the visit), etc.

In some embodiments, the information regarding risks associated with the area may include information regarding risk mitigation steps that have already taken place. In some embodiments, information regarding risk mitigation steps may include information about steps taken to remove or reduce the health and safety risks associated with the area. In some embodiments, information regarding risk mitigation steps may include information about: the current risk mitigation steps being taken (e.g., offices are being disinfected), when risk mitigation steps were taken (e.g., how recently was the office disinfected), air circulation patterns in the area (e.g., is the air ventilated so that air from one office stays in that office), the use of protective equipment (e.g., by people entering the area to sanitize it), the confidence level in the protective equipment (e.g., is it worn properly, is it a trusted brand or an unfamiliar brand, is it a type of the protective equipment with higher effectiveness or lower effectiveness), etc.

In some embodiments, the information regarding risks associated the area may include data obtained from monitoring people and activities in the area in real-time. In some embodiments, people and activities may be monitored in real-time or near real-time using internet-of-things devices. In some embodiments, real-time monitoring may be used to determine risk specific information about a person (e.g., coughing, sneezing, etc.). In some embodiments, real-time monitoring may be used to determine risk specific information from a group of people (e.g., to aggregate information about the behavior of multiple people), including: the percentage of people who used the hand sanitizer station in the building entry before pressing the elevator button, the percentage of people who touched the elevator button with their bare hands, the percentage of people who congregated in the area in groups of five or more, the percentage of people who failed to comply with usage of protective equipment (and the degree to which they did not comply), etc.

In some embodiments, real-time monitoring may be used to determine risk specific information about activities taking place in the area. For example, real-time or near real-time monitoring may be used to determine that: during a videoconference in a conference room, a person spent the hour-long meeting speaking into a handset of a speakerphone; in a building's cafeteria, people did not observe protocols to distance from one another while eating, etc. In some embodiments, real-time or near real-time monitoring may be used to determine specific information about risk mitigation in the area. For example, real-time monitoring may be used to determine if someone cleaned all the surfaces in an area or how long a disinfectant solution was left on a surface before it was wiped off.

As an example, the processor may receive information about the risk (e.g., a numerical risk evaluation) and an image of a body form to link the risk to a person through the body form. The risk may be about a pathogen and the likelihood that the person has the pathogen. The body form may be monitored (e.g., using an RFID tag, various other sensors, etc.) to learn the frequency of this individual with a particular risk evaluation going through an area. As another example, sensors may be embedded in protective equipment to learn how the protective equipment is being used (e.g., applied properly, replaced frequently enough, the quality of the equipment, etc.).

In some embodiments, the processor may determine, using a risk assessment AI model, a current risk evaluation associated with the area. In some embodiments, the current risk evaluation may be based on the aggregation of risk information regarding people, activities, and risk mitigation steps associated with the area. In some embodiments, the overall danger resulting from the risks from people and activities (and alleviated by risk mitigation steps) may be evaluated based on the health and safety guidance included in the information regarding risk mitigation approaches. In some embodiments, determining the current risk evaluation may involve determining a risk level (e.g., low, medium, or high). In some embodiments, determining the current risk evaluation may involve determining a risk rating on a numerical scale (e.g., 77 of 100, 1 out of 5, etc.). In some embodiments, the risk rating may be determined using a point allocation algorithm/model that sums together values assigned to incidents associated with people or activities having a risk value.

In some embodiments, an algorithm may be used to aggregate the risk in an area by assigning different risk points to different situations or events. For example, if a person without any known risks for a pathogen or wearing appropriate protective equipment enters the area, one point may be assigned. If a person coughs or sneezes in a part of the area, five points may be assigned to the subarea where the particles from the cough or sneeze are thought to disburse (e.g., calculated based on the height of the person and the type of droplets created). For every two feet of the area that the coughing person moved through, five points may be added. Points may be added if a person known to be infected enters the area (e.g., 100 points may be added for every five-foot path the infected person moved through). If a person known to be infected coughs or sneezes on an item, another 500 points may be added per item. As time passes and the area is not disinfected, one additional point may be added for every 30 minutes of time passed. If the area is properly sanitized, all of the assigned points may be subtracted. If the room was sanitized, but not sanitized properly, some points may not be subtracted. For example, a percentage of the points reflective of the percentage of deviation from the proper sanitization measures may be kept for the current risk evaluation for the area. In some embodiments, the points assigned to a scenario may be determined using the health and safety guidelines in the information regarding risk mitigation approaches.

In some embodiments, the risk assessment AI model may be trained to determine the current risk associated with the area based on the aggregate of risks from individuals and activities in the area utilizing data feeds from health and safety guidelines (e.g., the information about risk mitigation approaches stored in a knowledge corpus). In some embodiments, the risk assessment AI model may utilize deep learning techniques to learn risk mitigation approaches by evaluating publications, manuals, laws, best practices, location guidelines, etc. In some embodiments, the risk assessment AI model may utilize supervised learning techniques to review data from real-time monitoring of risk mitigation practices to learn to identify cases of non-compliant risk mitigation practices. In some embodiments, the risk assessment AI model may supplement its knowledge with unsupervised learning to identify negative outcomes that occurred in an area (e.g., associated with non-compliant risk mitigation practices) and improve its knowledge corpus.

In some embodiments, the current risk evaluation associated with the area may be communicated to a user via a graphical user interface of a user device. For example, the current risk evaluation may be communicated to people who are scheduled to enter the area (e.g., workers entering their work environment in a later shift), people responsible for taking recommended risk mitigation measures (e.g., building maintenance or safety coordinators), or people who have entered the area in the past during the time period over which the current risk evaluation was made (e.g., workers who worked in the area during the initial shift). In some embodiments, the current risk evaluation may include an evaluation of the risk to a particular individual. For example, a particular individual may work at a workstation in a doctor's office. The processor may determine a risk evaluation for the particular individual based on circumstances specific to the individual and the individual's actual or intended movement in the area. The processor may determine if another person is approaching (e.g., using real-time data) or scheduled to approach (e.g., using calendaring programs, people mapping, or information about the health care practitioners and patients who are scheduled to be in the area gathered from business records regarding medical appointments) the workstation.

In some embodiments, the processor may determine, using the risk assessment AI model, recommended risk mitigation measures based on the current risk evaluation. In some embodiments, the recommended risk mitigation measures may reduce the danger to the health or safety of people from the risks associated with the area. In some embodiments, the recommended risk mitigation measures may specify the supplies (e.g., cleaning solvent, brush, cloth, UV bulb type) and time (e.g., leave the cleaning solvent for 1 minute before wiping) required for the measures.

In some embodiment, the recommended risk mitigation measures may vary depending on the availability of supplies. For example, if ordinarily the risk mitigation measure includes using a disinfecting solvent to sanitize a surface, but there is a shortage of the disinfecting solvent, it may be recommended that only certain areas be sanitized with solvent and other areas be kept closed or cleaned using other approaches (e.g., the use of UV light or a less strong solution that needs to be in contact with the surface for longer time periods).

In some embodiment, the recommended risk mitigation measures may vary depending on the time available to take risk mitigation measures. For example, disinfecting a surface using one solution may require that the solution be left on a surface for five minutes before being wiped off, whereas using a different solution may require that the solution be left on for one minute before the solution is wiped off. If there are many surfaces that need to be disinfected but limited time in which to complete the risk mitigation measures, use of one solution may be recommended rather than use of another. In some embodiments, the recommended risk mitigation measures may include a prioritization of the risk mitigation measures that should be taken before others. In some embodiments, the prioritization may be based on the severity of the danger that the risk mitigation measure may alleviate.

In some embodiments, risk mitigation measures may be recommended based on optimizing the effectiveness of the risk mitigation (e.g., recommending the measures which result in elimination of 99% of the microbes on a surface rather than elimination of 80% of the microbes on a surface). In some embodiments, risk mitigation measures may be recommended based on an optimization of available time and/or resources (e.g., recommending risk mitigation measures where 100% of highly contaminated surfaces are disinfected to eliminate 80% of the microbes rather than recommending risk mitigation measures where 75% of the highly contaminated surfaces are disinfected to eliminate 98% of the microbes) given constraints of available supplies, personnel, time, etc. In some embodiments, the recommended risk mitigation measures may be based on the optimization of available time and/or resources to achieve risk mitigation which is within the guidance provided by the information regarding risk mitigation approaches.

In some embodiments, the recommended risk mitigation measures may be communicated to a user via a graphical user interface of a user device. For example, risk mitigation personnel may be provided with a list of the risk mitigation procedures to take (e.g., wipe all the surfaces with a sanitizing solvent, use a particular type of brush or cloth for certain surfaces, spray a disinfectant in the air), amount of time associated with the particular measure (e.g., allow the disinfectant solution to sit on a particular surface for five minutes), the order in which the risk mitigation measures may be taken (e.g., wipe surfaces in high traffic areas such as on elevator buttons and door handles first before disinfecting other areas), and a checkbox feature to monitor completion of specific tasks.

In some embodiments, the processor may further receive information regarding risks associated with the area that are predicted for a future time. In some embodiments, the processor may determine, using the risk assessment AI model, a future risk evaluation associated with the area. In some embodiments, the processor may determine, using the risk assessment AI model, recommended risk mitigation measures based on the future risk evaluation.

In some embodiments, the processor may utilize historical information about people entering the area (e.g., number of people who enter the area, surfaces that the people touch), activities (e.g., high risk activities like dental cleanings or low risk activities such as dental x-rays), and risk mitigation measures (e.g., when certain surfaces are sanitized throughout the day) to determine the future risk evaluation for the area. In some embodiments, the future risk evaluation may specify a time or time period associated with the risk level. For example, the system may be utilized to evaluate risks and risk mitigation measures in a factory that operates in two shifts. Based on the movement of people expected during the second shift, the activities predicted to take place during the second shift, and risk mitigation measures taken or predicted to be taken during a relevant time period (e.g., before or during the second shift), the risk assessment AI model may predict the risk to workers during the second shift at the factory. The future risk evaluation may include an evaluation of the risk at the beginning of the second shift and throughout the second shift as risk mitigation measures are taken during the second shift by health and safety employees (e.g., surfaces in high traffic areas may periodically be cleaned during the second shift while employees are still working).

In some embodiments, compliance with the recommended risk mitigation measures may be assessed. In some embodiments, compliance with the risk mitigation measures recommended based on the current risk evaluation or the future risk evaluation may be assessed by monitoring risk mitigation measures as they are performed. For example, sensors in an IoT environment may provide video feeds of remediation personnel wiping surfaces, spraying disinfectant on surfaces, leaving the disinfectant on the surface a certain time period, using specified cleaning tools (e.g., a new, sterile cleaning cloth for each surface or a particular brush for particular objects), etc. The video feeds may be used to determine compliance with the recommendations.

For example, the video feeds may be used to determine that one cleaning cloth was used for multiple offices, even though the recommended risk mitigation measures specified that a new cleaning cloth should be used for each office. In some embodiments, compliance with risk mitigation measures may be determined based, at least in part, on tracking the supply materials required for the risk mitigation measures (e.g., more cleaning clothes remain in the stock room than are expected indicating that new cleaning clothes are not used as frequently as they should) or self-reporting (e.g., remediation personnel reporting that during the time when the factory was closed, there was only enough time to sanitize according to proper standards 70% of the factory's assembly line surfaces). In some embodiments, the risk mitigation personnel may be informed of compliance with risk mitigation measures (e.g., informed if they have reached the relevant thresholds).

In some embodiments, the recommended risk mitigation measures may be revised, utilizing the risk assessment AI, based on the compliance with the risk mitigation measures. For example, after direct monitoring of people wiping highly contaminated surfaces, it may be observed that certain surfaces do not get wiped properly because of the geometry of the surfaces. The recommendation to wipe those surfaces may be changes to a recommendation to expose those surfaces to UV light. In some embodiments, based on observing that certain surfaces are being missed, the recommended risk mitigation measures may be revised to list the missed surfaces in a checklist.

In some embodiments, determining the risk mitigation measures may further include determining that the future risk is greater than or equal to a risk limit. In some embodiments, the processor may determine a time required for risk mitigation measures to decrease the future risk below a risk limit. For example, based on historical data and observed traffic of people going through a building's lobby during the hours that a business is open to customers, it may be determined that the number of people that passed through the lobby created a risk that the lobby may be contaminated with a pathogen, and the risk that the lobby may be contaminated with the pathogen is greater to or equal to a risk limit. As more people entered the lobby, the likelihood that a person infected with the pathogen entered the lobby increased, and the likelihood that multiple people infected with the pathogen entered the lobby also increased. The risk associated with this many people entering the lobby may be greater than or equal to a risk limit. For example, the risk limit may be a limit on the amount of risk that is reasonable or permissible (e.g., based on health and safety guidance) to expose people to. In some embodiments, the amount of time it would take to disinfect the lobby to bring the risk to below the risk limit may be determined (e.g., time to disinfect a certain number of surfaces in the lobby).

In some embodiments, determining the risk mitigation measures may further include determining an alternative area for use. Continuing the previous example, it may be determined that the amount of time required to bring the future risk to a level below the risk limit is less than the amount of time before employees that work the night shift come to work in the building. A recommendation may be provided to the night shift employees to enter the building through the side entrance rather than the building lobby during the duration of time required before the lobby can be sanitized (e.g., enough to bring the risk below the risk limit or to completely clean/sanitize the lobby).

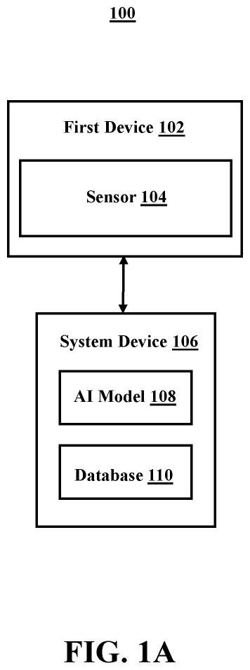

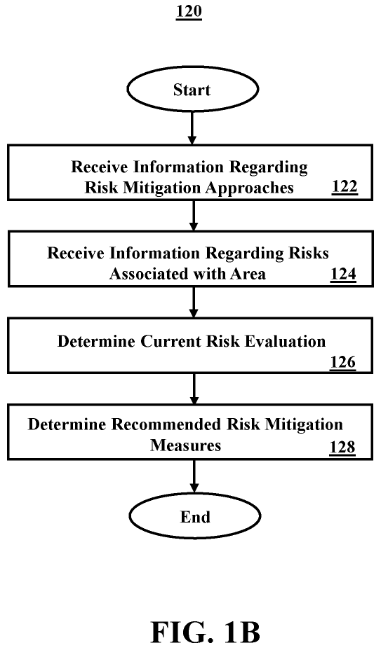

Referring now to FIG. 1A, a block diagram of a system 100 for determining risk mitigation measures based on a risk evaluation is illustrated. The system 100 includes a first device 102 and a system device 106. The system device 106 includes an AI model 108 and a database 110. The first device 102 and the system device 106 are configured to be in communication with each other. The first device 102 and the system device 106 may be any devices that contain a processor configured to perform one or more of the functions or steps described in this disclosure.

In some embodiments, a processor of the system device 106 receives information regarding risk mitigation approaches. The information regarding risk mitigation approaches is stored in the database 110 and is accessible to the AI model 108. The first device 102 may gather information regarding risks associated with an area using a sensor 104. The processor of system device 106 may receive the information regarding risks. The processor of system device 106 may use the AI model 108 to determine a current risk evaluation associated with the area. The processor of system device 106 may use the AI model 108 to determine recommended risk mitigation measures based on the current risk evaluation.

In some embodiments, the processor of system device 106 may further receive information regarding risks associated with the area that are predicted for a future time. In some embodiments, the processor of system device 106 may determine, using AI model 108, a future risk evaluation associated with the area. In some embodiments, the processor of system device 106 may determine, using AI model 108, recommended risk mitigation measures based on the future risk evaluation.

In some embodiments, the processor of system device 106 may further determine that the future risk is greater than or equal to a risk limit. In some embodiments, the processor of system device 106 may determine a time required for risk mitigation measures to decrease the future risk below a risk limit. In some embodiments, the processor of system device 106 may determine an alternative area for use.

In some embodiments, compliance with the recommended risk mitigation measures may be assessed using data from sensor 104. In some embodiments, the processor of system device 106 may revise recommended risk mitigation measures, utilizing the AI model 108, based on the compliance with the risk mitigation measures.

Referring now to FIG. 1B, illustrated is a flowchart of an exemplary method 120 in accordance with embodiments of the present disclosure. In some embodiments, a processor of the AI system may perform the operations of the method 120. In some embodiments, method 120 begins at operation 122. At operation 122, the processor receives information regarding risk mitigation approaches. The information regarding risk mitigation approaches may be stored in a database accessible to a risk assessment AI model. In some embodiments, method 120 proceeds to operation 124, where the processor receives information regarding risks associated with the area. In some embodiments, method 120 proceeds to operation 126. At operation 126, the processor determines, using the risk assessment AI model, a current risk evaluation associated with the area. In some embodiments, method 120 proceeds to operation 128. At operation 128, the processor determines, using the risk assessment AI model, recommended risk mitigation measures based on the current risk evaluation.

As discussed in more detail herein, it is contemplated that some or all of the operations of the method 120 may be performed in alternative orders or may not be performed at all; furthermore, multiple operations may occur at the same time or as an internal part of a larger process.

In some embodiments, discussed below, there are one or more operations of the method 120 not depicted for the sake of brevity. It is noted that some embodiments of the present disclosure and/or the method 120 utilize a blockchain structure. Accordingly, example embodiments further provide methods, systems, components, non-transitory computer readable media, devices, and/or networks, which provide a blockchain for determining risk mitigation measures based on a risk evaluation.

In some embodiments, the processor may generate a first data block of a blockchain ledger. In some embodiments, the first data block may have data regarding the risk mitigation approaches. In some embodiments, the processor may generate a second data block of the blockchain ledger. In some embodiments, the second data block may have data regarding the risks associated with the area. In some embodiments, the processor may generate a third data block of the blockchain ledger. In some embodiments, the third data block may have data regarding the current risk evaluation associated with the area. In some embodiments, the processor may generate a fourth data block of the blockchain ledger. In some embodiments, the fourth data block may have data regarding the recommended risk mitigation measures based on the current risk evaluation. In some embodiments, the processor may store the first data block, the second data block, the third data block, and the fourth data block in a chain in a secure data repository.

In some embodiments, the processor may generate a fifth data block of the blockchain ledger. In some embodiments, the fifth data block may have data regarding the risks predicted for a future time associated with the area. In some embodiments, the processor may generate a sixth data block of the blockchain ledger. In some embodiments, the sixth data block may have data regarding the future risk evaluation associated with the area. In some embodiments, the processor may generate a seventh data block of the blockchain ledger. In some embodiments, the seventh data block may have data regarding the future risk evaluation associated with the area. In some embodiments, the processor may store the fifth data block, the sixth data block, and the seventh data block in a chain in a secure data repository.

In some embodiments, the processor may generate an eight data block of the blockchain ledger. In some embodiments, the eight data block may have data regarding the compliance with the risk mitigation measures. In some embodiments, the processor may store the eight data block in a chain in a secure data repository. In some embodiments, each data block may be committed to the blockchain ledger after each action described above. In other embodiments, each block may be representative of an individual transaction and a single block may be committed to the blockchain ledger after each of the actions described above is performed.

In one embodiment the application utilizes a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency. In various embodiments, a permissioned and/or a permissionless blockchain can be used. In a public or permission-less blockchain, anyone can participate without a specific identity. Public blockchains can involve native cryptocurrency and use consensus based on various protocols such as Proof of Work (PoW). On the other hand, a permissioned blockchain database provides secure interactions among a group of entities which share a common goal but which do not fully trust one another, such as businesses that exchange funds, goods, information, and the like.

This application can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The application can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded. An endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

In some embodiments, the method, system, and/or computer program product can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node).

Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing transactions and modifying a world state of the blockchain, which is another name for the initial blockchain transaction which normally includes control and setup information.

In some embodiment, the method, system, and/or computer program product can utilize a ledger that is a sequenced, tamper-resistant record of all state transitions of a blockchain. State transitions may result from chaincode invocations (i.e., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain.

In some embodiment, the method, system, and/or computer program product described herein can utilize a chain that is a transaction log that is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (i.e., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Blockchain is different from a traditional database in that blockchain is not a central storage, but rather a decentralized, immutable, and secure storage, where nodes must share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the system described herein is implemented due to immutable accountability, security, privacy, permitted decentralization, availability of smart contracts, endorsements and accessibility that are inherent and unique to blockchain.

In particular, the blockchain ledger data is immutable and that provides for an efficient method for determining if risk mitigation measures were properly executed and to protect information associated with users. Also, use of the encryption in the blockchain provides security and builds trust. The smart contract manages the state of the asset to complete the life-cycle. The example blockchains are permission decentralized. Thus, each end user may have its own ledger copy to access. Multiple organizations (and peers) may be on-boarded on the blockchain network. The key organizations may serve as endorsing peers to validate the smart contract execution results, read-set and write-set. In other words, the blockchain inherent features provide for efficient implementation of processing a private transaction in a blockchain network.

The example embodiments provide numerous benefits over a traditional database. For example, through the blockchain the embodiments provide for immutable accountability, security, privacy, permitted decentralization, availability of smart contracts, endorsements and accessibility that are inherent and unique to the blockchain.

A traditional database could not be used to implement the example embodiments because it does not bring all parties on the network, it does not create trusted collaboration, and does not provide for an efficient storage of digital assets. The traditional database does not provide for a tamper proof storage and does not provide for preservation of the digital assets being stored. As a result, the proposed embodiments described herein utilizing blockchain networks cannot be implemented in the traditional database.

If a traditional database were to be used to implement the example embodiments, the example embodiments would have suffered from unnecessary drawbacks such as search capability, lack of security and slow speed of transactions. Accordingly, the example embodiments provide for a specific solution to a problem in the arts/field of risk management/mitigation.

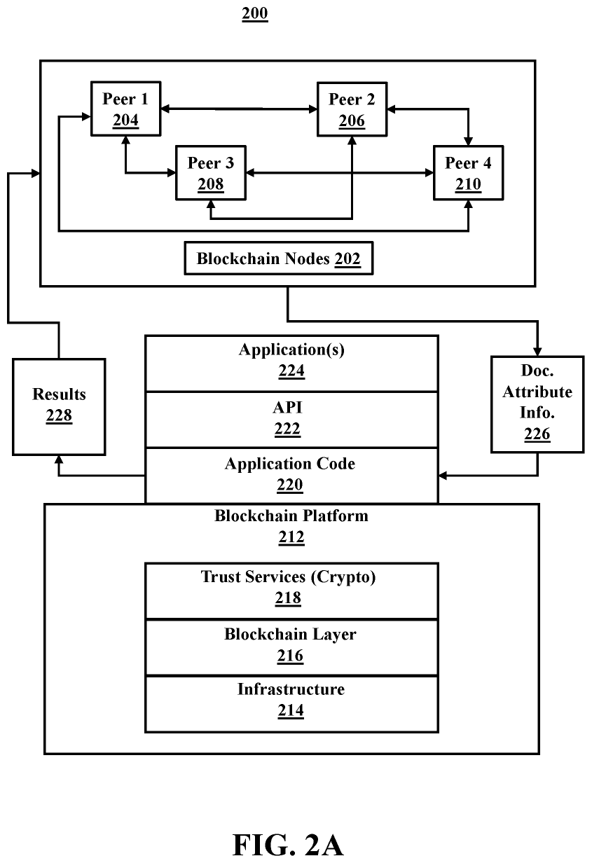

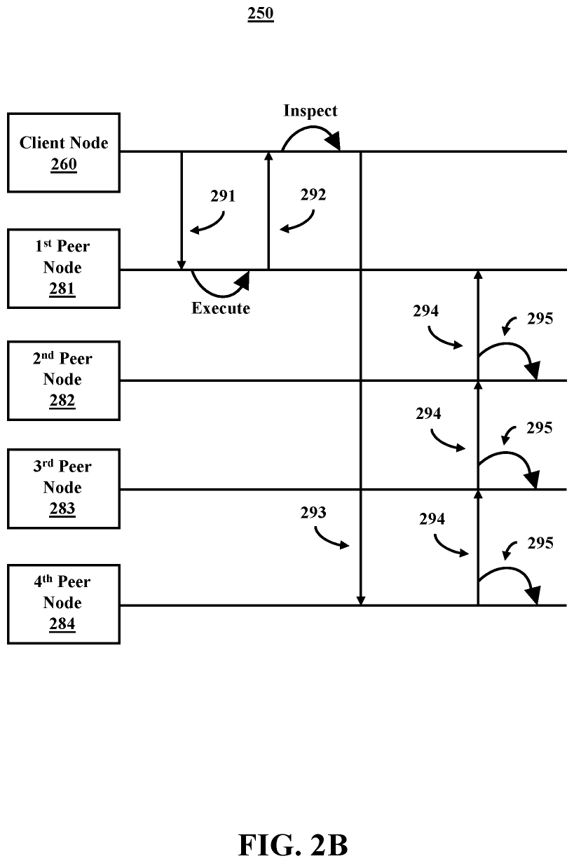

FIG. 2A illustrates a blockchain architecture configuration 200, according to example embodiments. Referring to FIG. 2A, the blockchain architecture 200 may include certain blockchain elements, for example, a group of blockchain nodes 202. The blockchain nodes 202 may include one or more nodes 204-210 (these four nodes are depicted by example only). These nodes participate in a number of activities, such as blockchain transaction addition and validation process (consensus). One or more of the blockchain nodes 204-210 may endorse transactions based on endorsement policy and may provide an ordering service for all blockchain nodes in the architecture 200. A blockchain node may initiate a blockchain authentication and seek to write to a blockchain immutable ledger stored in blockchain layer 216, a copy of which may also be stored on the underpinning physical infrastructure 214. The blockchain configuration may include one or more applications 224 which are linked to application programming interfaces (APIs) 222 to access and execute stored program/application code 220 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 204-210.

The blockchain base or platform 212 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 216 may expose an interface that provides access to the virtual execution environment necessary to process the program code and engage the physical infrastructure 214. Cryptographic trust services 218 may be used to verify transactions such as asset exchange transactions and keep information private.

The blockchain architecture configuration of FIG. 2A may process and execute program/application code 220 via one or more interfaces exposed, and services provided, by blockchain platform 212. The code 220 may control blockchain assets. For example, the code 220 can store and transfer data, and may be executed by nodes 204-210 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the document attribute(s) information 226 may be processed by one or more processing entities (e.g., virtual machines) included in the blockchain layer 216. The result 228 may include a plurality of linked shared documents. The physical infrastructure 214 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

FIG. 2B illustrates an example of a blockchain transactional flow 250 between nodes of the blockchain in accordance with an example embodiment. Referring to FIG. 2B, the transaction flow may include a transaction proposal 291 sent by an application client node 260 to an endorsing peer node 281. The endorsing peer 281 may verify the client signature and execute a chaincode function to initiate the transaction. The output may include the chaincode results, a set of key/value versions that were read in the chaincode (read set), and the set of keys/values that were written in chaincode (write set). The proposal response 292 is sent back to the client 260 along with an endorsement signature, if approved. The client 260 assembles the endorsements into a transaction payload 293 and broadcasts it to an ordering service node 284. The ordering service node 284 then delivers ordered transactions as blocks to all peers 281-283 on a channel. Before committal to the blockchain, each peer 281-283 may validate the transaction. For example, the peers may check the endorsement policy to ensure that the correct allotment of the specified peers have signed the results and authenticated the signatures against the transaction payload 293.

Referring again to FIG. 2B, the client node 260 initiates the transaction 291 by constructing and sending a request to the peer node 281, which is an endorser. The client 260 may include an application leveraging a supported software development kit (SDK), which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 281 may verify (a) that the transaction proposal is well formed, (b) the transaction has not been submitted already in the past (replay-attack protection), (c) the signature is valid, and (d) that the submitter (client 260, in the example) is properly authorized to perform the proposed operation on that channel. The endorsing peer node 281 may take the transaction proposal inputs as arguments to the invoked chaincode function. The chaincode is then executed against a current state database to produce transaction results including a response value, read set, and write set. However, no updates are made to the ledger at this point. In 292, the set of values, along with the endorsing peer node's 281 signature is passed back as a proposal response 292 to the SDK of the client 260 which parses the payload for the application to consume.

In response, the application of the client 260 inspects/verifies the endorsing peers signatures and compares the proposal responses to determine if the proposal response is the same. If the chaincode only queried the ledger, the application would inspect the query response and would typically not submit the transaction to the ordering node service 284. If the client application intends to submit the transaction to the ordering node service 284 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node will need to endorse the transaction. The architecture is such that even if an application selects not to inspect responses or otherwise forwards an unendorsed transaction, the endorsement policy will still be enforced by peers and upheld at the commit validation phase.

After successful inspection, in step 293 the client 260 assembles endorsements into a transaction and broadcasts the transaction proposal and response within a transaction message to the ordering node 284. The transaction may contain the read/write sets, the endorsing peers signatures and a channel ID. The ordering node 284 does not need to inspect the entire content of a transaction in order to perform its operation, instead the ordering node 284 may simply receive transactions from all channels in the network, order them chronologically by channel, and create blocks of transactions per channel.

The blocks of the transaction are delivered from the ordering node 284 to all peer nodes 281-283 on the channel. The transactions 294 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 295 each peer node 281-283 appends the block to the channel's chain, and for each valid transaction the write sets are committed to current state database. An event is emitted, to notify the client application that the transaction (invocation) has been immutably appended to the chain, as well as to notify whether the transaction was validated or invalidated.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

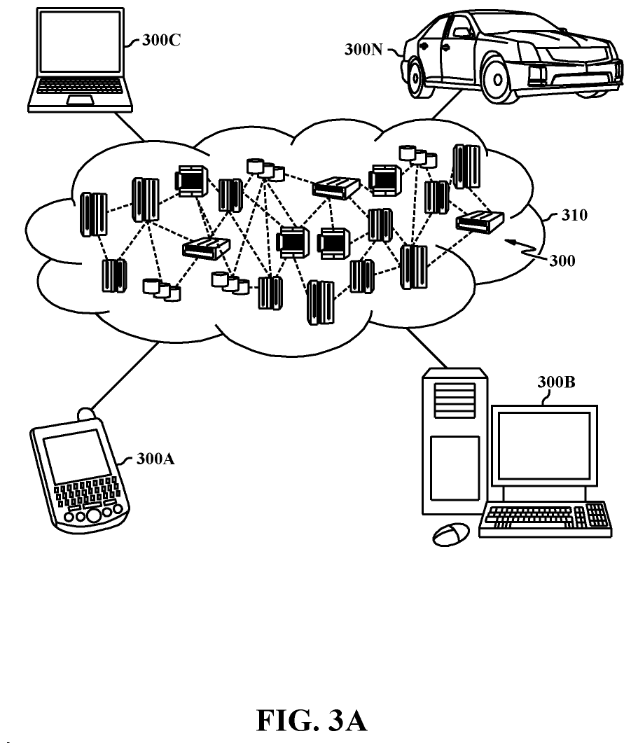

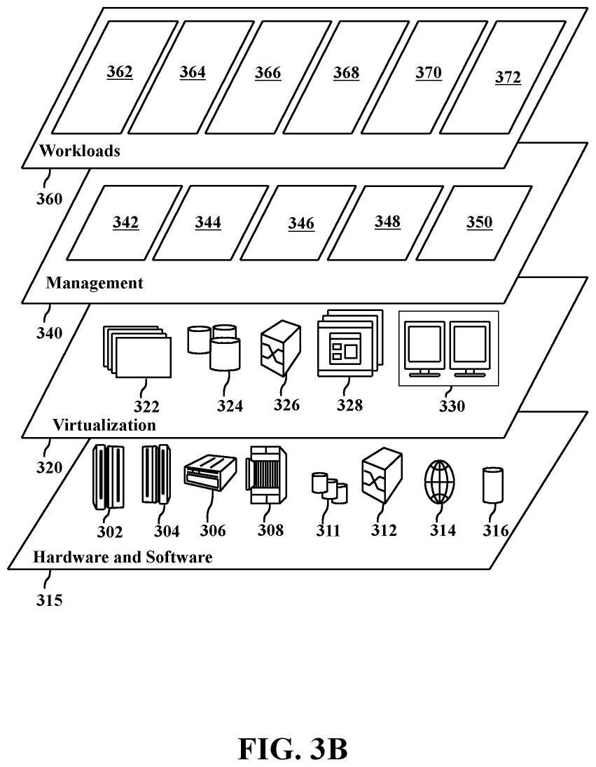

FIG. 3A, illustrated is a cloud computing environment 310 is depicted. As shown, cloud computing environment 310 includes one or more cloud computing nodes 300 with which local computing devices used by cloud consumers, such as, for example, personal digital assistant (PDA) or cellular telephone 300A, desktop computer 300B, laptop computer 300C, and/or automobile computer system 300N may communicate. Nodes 300 may communicate with one another. They may be grouped (not shown) physically or virtually, in one or more networks, such as Private, Community, Public, or Hybrid clouds as described hereinabove, or a combination thereof.

This allows cloud computing environment 310 to offer infrastructure, platforms and/or software as services for which a cloud consumer does not need to maintain resources on a local computing device. It is understood that the types of computing devices 300A-N shown in FIG. 3A are intended to be illustrative only and that computing nodes 300 and cloud computing environment 310 can communicate with any type of computerized device over any type of network and/or network addressable connection (e.g., using a web browser).

FIG. 3B, illustrated is a set of functional abstraction layers provided by cloud computing environment 310 (FIG. 3A) is shown. It should be understood in advance that the components, layers, and functions shown in FIG. 3B are intended to be illustrative only and embodiments of the disclosure are not limited thereto. As depicted below, the following layers and corresponding functions are provided.

Hardware and software layer 315 includes hardware and software components. Examples of hardware components include: mainframes 302; RISC (Reduced Instruction Set Computer) architecture based servers 304; servers 306; blade servers 308; storage devices 311; and networks and networking components 312. In some embodiments, software components include network application server software 314 and database software 316.

Virtualization layer 320 provides an abstraction layer from which the following examples of virtual entities may be provided: virtual servers 322; virtual storage 324; virtual networks 326, including virtual private networks; virtual applications and operating systems 328; and virtual clients 330.

In one example, management layer 340 may provide the functions described below. Resource provisioning 342 provides dynamic procurement of computing resources and other resources that are utilized to perform tasks within the cloud computing environment. Metering and Pricing 344 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 346 provides access to the cloud computing environment for consumers and system administrators. Service level management 348 provides cloud computing resource allocation and management such that required service levels are met. Service Level Agreement (SLA) planning and fulfillment 350 provide pre-arrangement for, and procurement of, cloud computing resources for which a future requirement is anticipated in accordance with an SLA.

Workloads layer 360 provides examples of functionality for which the cloud computing environment may be utilized. Examples of workloads and functions which may be provided from this layer include: mapping and navigation 362; software development and lifecycle management 364; virtual classroom education delivery 366; data analytics processing 368; transaction processing 370; and determining risk mitigation measures based on a risk evaluation 372.

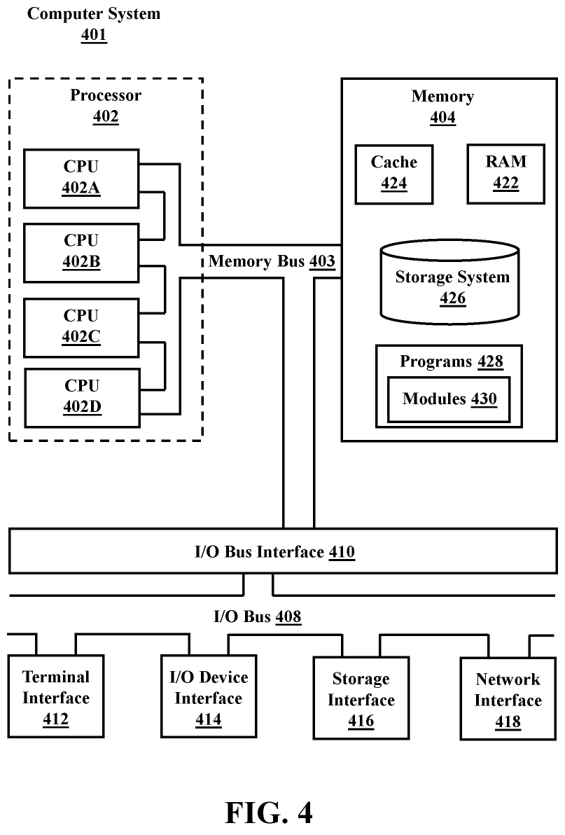

FIG. 4, illustrated is a high-level block diagram of an example computer system 401 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 401 may comprise one or more CPUs 402, a memory subsystem 404, a terminal interface 412, a storage interface 416, an I/O (Input/Output) device interface 414, and a network interface 418, all of which may be communicatively coupled, directly or indirectly, for inter-component communication via a memory bus 403, an I/O bus 408, and an I/O bus interface unit 410.

The computer system 401 may contain one or more general-purpose programmable central processing units (CPUs) 402A, 402B, 402C, and 402D, herein generically referred to as the CPU 402. In some embodiments, the computer system 401 may contain multiple processors typical of a relatively large system; however, in other embodiments the computer system 401 may alternatively be a single CPU system. Each CPU 402 may execute instructions stored in the memory subsystem 404 and may include one or more levels of on-board cache.

System memory 404 may include computer system readable media in the form of volatile memory, such as random access memory (RAM) 422 or cache memory 424. Computer system 401 may further include other removable/non-removable, volatile/non-volatile computer system storage media. By way of example only, storage system 426 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 404 can include flash memory, e.g., a flash memory stick drive or a flash drive. Memory devices can be connected to memory bus 403 by one or more data media interfaces. The memory 404 may include at least one program product having a set (e.g., at least one) of program modules that are configured to carry out the functions of various embodiments.

One or more programs/utilities 428, each having at least one set of program modules 430 may be stored in memory 404. The programs/utilities 428 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 428 and/or program modules 430 generally perform the functions or methodologies of various embodiments.

Although the memory bus 403 is shown in FIG. 4 as a single bus structure providing a direct communication path among the CPUs 402, the memory subsystem 404, and the I/O bus interface 410, the memory bus 403 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 410 and the I/O bus 408 are shown as single respective units, the computer system 401 may, in some embodiments, contain multiple I/O bus interface units 410, multiple I/O buses 408, or both. Further, while multiple I/O interface units are shown, which separate the I/O bus 408 from various communications paths running to the various I/O devices, in other embodiments some or all of the I/O devices may be connected directly to one or more system I/O buses.

In some embodiments, the computer system 401 may be a multi-user mainframe computer system, a single-user system, or a server computer or similar device that has little or no direct user interface, but receives requests from other computer systems (clients). Further, in some embodiments, the computer system 401 may be implemented as a desktop computer, portable computer, laptop or notebook computer, tablet computer, pocket computer, telephone, smartphone, network switches or routers, or any other appropriate type of electronic device.

It is noted that FIG. 4 is intended to depict the representative major components of an exemplary computer system 401. In some embodiments, however, individual components may have greater or lesser complexity than as represented in FIG. 4, components other than or in addition to those shown in FIG. 4 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

What is claimed is:

1. A method for determining risk mitigation needs in an area, the method comprising:
receiving, using a processor, information regarding risk mitigation approaches, wherein the information regarding risk mitigation approaches is stored in a database accessible to a risk assessment AI model;
receiving information regarding risks associated with the area;
determining, using the risk assessment AI model, a current risk evaluation associated with the area; and
determining, using the risk assessment AI model, recommended risk mitigation measures based on the current risk evaluation.

2. The method of claim 1, further including:
generating a first data block of a blockchain ledger, the first data block having data regarding the risk mitigation approaches;
generating a second data block of the blockchain ledger, the second data block having data regarding the risks associated with the area;
generating a third data block of the blockchain ledger, the third data block having data regarding the current risk evaluation associated with the area;
generating a fourth data block of the blockchain ledger, the fourth data block having data regarding the recommended risk mitigation measures based on the current risk evaluation; and
storing the first data block, the second data block, the third data block, and the fourth data block in a chain in a secure data repository.

3. The method of claim 1, wherein information regarding risks associated with the area includes data obtained from monitoring people and activities in the area in real-time.

4. The method of claim 1, further including:
receiving information regarding risks associated with the area that are predicted for a future time;
determining, using the risk assessment AI model, a future risk evaluation associated with the area; and
determining, using the risk assessment AI model, recommended risk mitigation measures based on the future risk evaluation.

5. The method of claim 4, wherein determining the risk mitigation measures further includes:
determining that the future risk is greater than or equal to a risk limit; and
determining a time required for risk mitigation measures to decrease the future risk below the risk limit.

6. The method of claim 5, wherein determining the risk mitigation measures further includes:
determining an alternative area for use.

7. The method of claim 4, further including:
generating a fifth data block of the blockchain ledger, the fifth data block having data regarding the risks predicted for a future time associated with the area;
generating a sixth data block of the blockchain ledger, the sixth data block having data regarding the future risk evaluation associated with the area;
generating a seventh data block of the blockchain ledger, the seventh data block having data regarding the future risk evaluation associated with the area; and
storing the fifth data block, the sixth data block, and the seventh data block in a chain in a secure data repository.

8. The method of claim 4, further comprising assessing compliance with the recommended risk mitigation measures.

9. The method of claim 8, further including:
generating an eight data block of the blockchain ledger, the eight data block having data regarding the compliance with the risk mitigation measures; and
storing the eight data block in a chain in a secure data repository.

10. The method of claim 8, further comprising revising the recommended risk mitigation measures, utilizing the risk assessment AI model, based on the compliance with the risk mitigation measures.

11. A system comprising:
a memory; and
a processor in communication with the memory, the processor being configured to perform operations comprising:
receiving information regarding risk mitigation approaches, wherein the information regarding risk mitigation approaches is stored in a database accessible to a risk assessment AI model;
receiving information regarding risks associated with the area;
determining, using the risk assessment AI model, a current risk evaluation associated with the area; and
determining, using the risk assessment AI model, recommended risk mitigation measures based on the current risk evaluation.

12. The system of claim 11, the processor being further configured to perform operations comprising:
receiving information regarding risks associated with the area that are predicted for a future time;
determining, using the risk assessment AI model, a future risk evaluation associated with the area; and
determining, using the risk assessment AI model, recommended risk mitigation measures based on the future risk evaluation.

13. The system of claim 12, wherein determining the risk mitigation measures further includes:
determining that the future risk is greater than or equal to a risk limit;
determining a time required for risk mitigation measures to decrease the future risk below the risk limit; and
determining an alternative area for use.

14. The system of claim 12, the processor being further configured to perform operations comprising: assessing compliance with the recommended risk mitigation measures.

15. The system of claim 14, the processor being further configured to perform operations comprising: revising the recommended risk mitigation measures, utilizing the risk assessment AI model, based on the compliance with the risk mitigation measures.

16. A computer program product comprising a computer readable storage medium having program instructions embodied therewith, the program instructions executable by a processor to cause the processor to perform operations, the operations comprising:
receiving information regarding risk mitigation approaches, wherein the information regarding risk mitigation approaches is stored in a database accessible to a risk assessment AI model;
receiving information regarding risks associated with the area;
determining, using the risk assessment AI model, a current risk evaluation associated with the area; and
determining, using the risk assessment AI model, recommended risk mitigation measures based on the current risk evaluation.

17. The computer program product of claim 16, the processor being further configured to perform operations comprising:
receiving information regarding risks associated with the area that are predicted for a future time;
determining, using the risk assessment AI model, a future risk evaluation associated with the area; and
determining, using the risk assessment AI model, recommended risk mitigation measures based on the future risk evaluation.

18. The computer program product of claim 17, wherein determining the risk mitigation measures further includes:
determining that the future risk is greater than or equal to a risk limit;
determining a time required for risk mitigation measures to decrease the future risk below the risk limit; and
determining an alternative area for use.

19. The computer program product of claim 16, the processor being further configured to perform operations comprising: assessing compliance with the recommended risk mitigation measures.

20. The computer program product of claim 19, the processor being further configured to perform operations comprising: revising the recommended risk mitigation measures, utilizing the risk assessment AI model, based on the compliance with the risk mitigation measures.
